(19) United States
(12) Patent Application Publication
(10) Pub. No.: US 2024/0367553 A1
(43) Pub. Date: Nov. 7, 2024

(54) BATTERY SELF-HEATING APPARATUS AND METHOD, AND VEHICLE

(71) Applicant: BYD COMPANY LIMITED, Shenzhen (CN)

(72) Inventors: Heping LING, Shenzhen (CN); Lei YAN, Shenzhen (CN); Zhen ZHAI, Shenzhen (CN); Wen GAO, Shenzhen (CN); Ke ZHU, Shenzhen (CN)

(21) Appl. No.: 18/777,800

(22) Filed: Jul. 19, 2024

Related U.S. Application Data
(63) Continuation of application No. PCT/CN2023/074134, filed on Feb. 1, 2023.

(30) Foreign Application Priority Data
Mar. 31, 2022 (CN) 202210346572.X

(51) Int. Cl. B60L 58/27; B60L 50/60; B60L 53/24; H01M 10/615; H01M 10/625; H01M 10/637

(52) U.S. Cl. CPC B60L 58/27; B60L 50/60; B60L 53/24; H01M 10/615; H01M 10/625; H01M 10/637; H01M 2220/20

(57) ABSTRACT

A battery self-heating apparatus and method, and a vehicle include a first energy processing apparatus, a second energy processing apparatus, and a controller connected to each other. The controller is configured to control connect/disconnect of a first inverter and a second inverter in a first preset state, to enable a first power battery and a second power battery to be charged/discharged through the first energy processing apparatus and the second energy processing apparatus, to implement heating of the first power battery and the second power battery.

### CROSS-REFERENCE TO RELATED APPLICATIONS

The present application is a continuation application of PCT application No. PCT/CN2023/074134, filed on Feb. 1, 2023, which claims priority to Chinese Patent Application No. 202210346572.X, entitled “BATTERY SELF-HEATING APPARATUS AND METHOD, AND VEHICLE” filed on Mar. 31, 2022, content of all of which is incorporated herein by reference in its entirety.

### FIELD

The present disclosure relates to the field of vehicles, and specifically, to a battery self-heating apparatus and method, and a vehicle.

### BACKGROUND

In a low temperature environment, charging performance of a pure electric vehicle decreases. Therefore, a power battery of the pure electric vehicle needs to be heated, to increase a body temperature of the power battery, and ensure a power of the pure electric vehicle in cold conditions.

In the related art, a battery heating method mainly includes external heating and internal heating. The external heating means that a battery is heated by adding an additional heating device. In such a heating manner, cost is high, and heating efficiency is low. A principle of the internal heating is: performing charging and discharging by mainly using a battery cycle, and generating heat relying on internal resistance of the battery. However, a heating power is limited in a currently achievable battery self-heating technology.

### SUMMARY

An objective of the present disclosure is to provide a battery self-heating apparatus and method, and a vehicle, to resolve or partially resolve the foregoing technical problems.

To implement the foregoing objective, the present disclosure provides a battery self-heating apparatus, including a first energy processing apparatus, a second energy processing apparatus, and a controller connected to each other. The first energy processing apparatus includes the first inverter and a first motor, and the second energy processing apparatus includes the second inverter and a second motor. A first bus terminal of the first inverter is connected to a positive electrode of the first power battery, and a second bus terminal of the first inverter is connected to a negative electrode of the first power battery, a negative electrode of the second power battery, and a second bus terminal of the second inverter. A first terminal of the first motor is connected to a midpoint of the first inverter, a first terminal of the second motor is connected to a midpoint of the second inverter, and a second terminal of the first motor is jointly connected to form a first neutral point, and the first neutral point is connected to a second neutral point formed by commonly connecting a second terminal of the second motor, through a neutral line. The controller is configured to control connect/disconnect of the first inverter and the second inverter in a first preset state, to enable the first power battery and the second power battery to be charged/discharged through the first energy processing apparatus and the second energy processing apparatus, to implement heating of the first power battery and the second power battery.

The present disclosure further provides a battery self-heating method, including: controlling connect/disconnect of a first inverter and a second inverter in a first preset state, to enable a first power battery and a second power battery to be charged/discharged through a first energy processing apparatus and a second energy processing apparatus, to implement heating of the first power battery and the second power battery. The first energy processing apparatus includes the first inverter and a first motor, and the second energy processing apparatus includes the second inverter and a second motor. A first bus terminal of the first inverter is connected to a positive electrode of the first power battery, and a second bus terminal of the first inverter is connected to a negative electrode of the first power battery, a negative electrode of the second power battery, and a second bus terminal of the second inverter. A first terminal of the first motor is connected to a midpoint of the first inverter, a first terminal of the second motor is connected to a midpoint of the second inverter, and a second terminal of the first motor is jointly connected to form a first neutral point, and the first neutral point is connected to a second neutral point formed by commonly connecting a second terminal of the second motor, through a neutral line.

The present disclosure further provides an electric vehicle, including the battery self-heating apparatus.

Through the foregoing technical solution, a battery self-heating apparatus that performs low-frequency oscillation heating by using dual motors and dual electric controls is provided, which may fully use characteristics that some electric vehicles such as a four-wheel drive electric vehicle have the dual motors and the dual electric controls. By connecting the dual motors through the neutral line, self-heating efficiency and a power of the power battery are greatly improved, and a lower cost is ensured.

Other features and advantages of the present disclosure will be described in detail in the following detailed implementation part.

### BRIEF DESCRIPTION OF THE DRAWINGS

The accompanying drawings are intended to provide further understanding of the present disclosure and constitute a part of this specification. The accompanying drawings and the specific implementations below are used together for explaining the present disclosure rather than constituting a limitation to the present disclosure. In the accompanying drawings,

FIG. 1 is a schematic diagram of a structure of a battery self-heating apparatus according to an exemplary embodiment of the present disclosure;

FIG. 2 is a schematic diagram of a structure of a battery self-heating apparatus according to still another exemplary embodiment of the present disclosure;

FIG. 3 is a schematic diagram of a structure of a battery self-heating apparatus according to still another exemplary embodiment of the present disclosure;

FIG. 4 is a schematic diagram of a structure of a battery self-heating apparatus according to still another exemplary embodiment of the present disclosure;

FIG. 5 is a schematic diagram of a structure of a battery self-heating apparatus according to still another exemplary embodiment of the present disclosure;

FIG. 6 is a schematic diagram of a structure of a battery self-heating apparatus according to still another exemplary embodiment of the present disclosure;

FIG. 7 is a schematic diagram of terminal points of a seventh switch and an eighth switch in a battery self-heating apparatus according to still another exemplary embodiment of the present disclosure;

FIG. 8 is a flowchart of a battery self-heating method according to an exemplary embodiment of the present disclosure; and

FIG. 9 is a structural block diagram of an electric vehicle according to an exemplary embodiment of the present disclosure.

### DETAILED DESCRIPTION

Certain implementations of the present disclosure are described in detail below with reference to the accompanying drawings. It should be understood that the specific implementations described herein are merely used to describe and explain the present disclosure, but are not intended to limit the present disclosure.

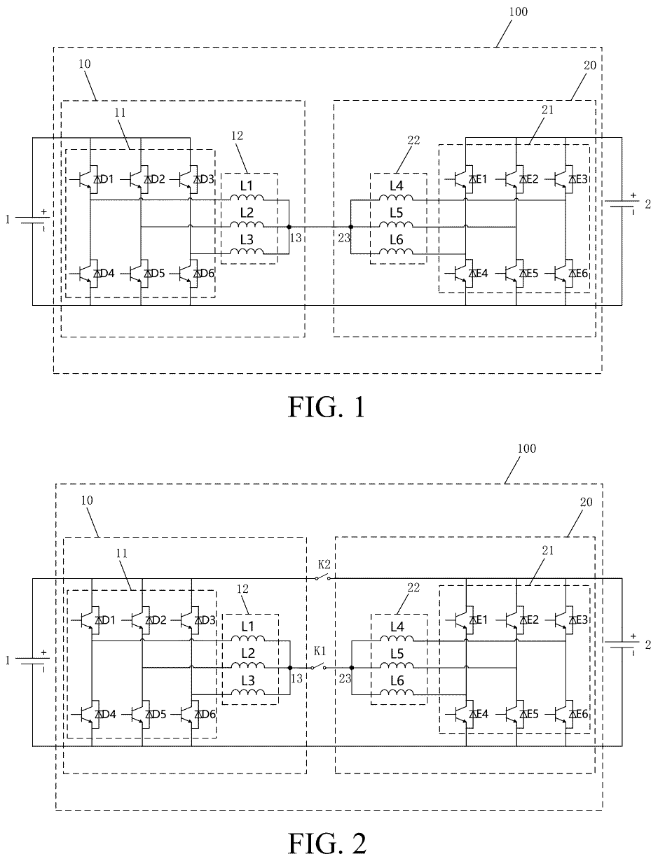

FIG. 1 is a schematic diagram of a structure of a battery self-heating apparatus according to an embodiment of the present disclosure. As shown in FIG. 1, the apparatus includes a first energy processing apparatus 10, a second energy processing apparatus 20, and a controller (not shown) connected to each other. The first energy processing apparatus 10 includes a first inverter 11 and a first motor 12, and the second energy processing apparatus 20 includes a second inverter 21 and a second motor 22. A first bus terminal of the first inverter 11 is connected to a positive electrode of a first power battery 1, a second bus terminal of the first inverter 11 is connected to a negative electrode of the first power battery 1, a negative electrode of a second power battery 2, and a second bus terminal of the second inverter 21. A first terminal of the first motor 12 is connected to a midpoint of the first inverter 11, a first terminal of the second motor 22 is connected to a midpoint of the second inverter 21, and a second terminal of the first motor 12 is jointly connected to form a first neutral point 13, and the first neutral point is connected to a second neutral point 23 formed by commonly connecting a second terminal of the second motor 22, through a neutral line. The controller is configured to control connect/disconnect of the first inverter 11 and the second inverter 21 in a first preset state, to enable the first power battery 1 and the second power battery 2 to be charged/discharged through the first energy processing apparatus 10 and the second energy processing apparatus 20, to implement heating of the first power battery 1 and the second power battery 2.

Both the first power battery 1 and the second power battery 2 shown in FIG. 1 may be power batteries in a same electric vehicle. The first energy processing apparatus 10 and the second energy processing apparatus 20 may also be components of the same electric vehicle. The electric vehicle may include an electric or hybrid vehicle, ship, airplane, or the like. The following descriptions mainly use the vehicle as an example. For example, a current four-wheel drive electric vehicle mostly uses a system with dual motors and dual electronic controls. The first inverter 11 may be an inverter in a first motor controller in the vehicle. The first motor 12 may be a first motor controlled by the first motor controller in the vehicle. The second inverter 21 may be an inverter in a second motor controller in the vehicle. The second motor 22 may be a second motor controlled by the second motor controller in the vehicle.

The first preset state may be a state in which the first power battery 1 and the second power battery 2 need to be heated. For example, a power of the first power battery 1 and a power of the second power battery 2 are lower than a preset power threshold, or a temperature of the first power battery 1 and a temperature of the second power battery 2 are lower than a preset temperature threshold.

The controller controls connect/disconnect of the first inverter 11 and the second inverter 21 in the first preset state, so that an oscillating current is generated between the first power battery 1 and the second power battery 2 through the first energy processing apparatus 10 and the second energy processing apparatus 20, to enable the first power battery 1 and the second power battery 2 to be charged/discharged, to implement heating of the first power battery 1 and the second power battery 2. In this way, in comparison to a solution in which only a single motor and a single electronic control in the vehicle are used to perform battery self-heating, when the two motors and the two electronic controls in the vehicle are included in a battery oscillation heating process, an added motor and an added electronic control further generate heat in the self-heating process, and the heat generated is at least twice the heat generated by an original single motor and single electronic control for self-heating, which may greatly improve battery self-heating efficiency. In addition, due to a high increase in heat production, when there is excess heating heat needed by the battery, the excess heat may be further exported through a heat pump, to provide a heat source for a vehicle passenger compartment, thereby reducing energy that needs to be consumed when the vehicle passenger compartment is heated. In addition, because both the first energy processing apparatus 10 and the second energy processing apparatus 20 may be original components in the vehicle, existing components in the vehicle may be fully used to heat a power battery of the vehicle, thereby reducing costs.

Bridge arms in the first inverter 11 and the second inverter 21 may be three-phase bridge arms as shown in FIG. 1, or may be bridge arms of other quantities. The bridge arms in FIG. 1 are only illustrative. A quantity of motor windings included in the first motor 12 and the second motor 22 respectively corresponds to the quantity of bridge arms in the first inverter 11 and the second inverter 21.

An example in which the bridge arms in the first inverter 11 and the second inverter 21 shown in FIG. 1 are three-phase bridge arms, and the first motor 12 and the second motor 22 include three motor windings (L1, L2, L3, L4, L5, and L6 respectively) is used. The controller may control upper bridge arms of the first inverter 11 and lower bridge arms of the second inverter 21 to be simultaneously closed in the first preset state, or control lower bridge arms of the first inverter 11 and upper bridge arms of the second inverter 21 to be simultaneously closed, to implement self-heating of the first power battery 1 and the second power battery 2. In the heating period, current states in the first energy processing apparatus 10 and the second energy processing apparatus 20 may include the following four states.

State 1: Three upper bridge arms (D1, D2, and D3) in the first inverter 11 and three lower bridge arms (E4, E5, and E6) in the second inverter 21 are controlled to be closed. Three lower bridge arms (D4, D5, and D6) in the first inverter 11 and three upper bridge arms (E1, E2, and E3) in the second inverter 21 are controlled to be opened. The first power battery 1 is discharged externally, and the first motor 12 and the second motor 22 store energy. A current flows out from the positive electrode of the first power battery 1, flows to the first motor 12 through the three upper bridge arms (D1, D2, and D3) in the first inverter 11, then flows out from the second motor 22 through a neutral line between the first motor 12 and the second motor 22, and flows back to the negative electrode of the first power battery 1 through the three lower bridge arms (E4, E5, and E6) in the second inverter 21. In this state, the first power battery 1 is discharged, the first motor 12 and the second motor 22 are charged, and a voltage in the first power battery 1 drops.

State 2: The three lower bridge arms (D4, D5, and D6) in the first inverter 11 and the three upper bridge arms (E1, E2, and E3) in the second inverter 21 are controlled to be closed. The three upper bridge arms (D1, D2, and D3) in the first inverter 11 and the three lower bridge arms (E4, E5, and E6) in the second inverter 21 are controlled to be opened. Because the current on the motor winding 20 cannot change suddenly, currents in the first motor 12 and the second motor 22 continue to flow. The freewheeling currents flow through diodes connected in anti-parallel in the three upper bridge arms (E1, E2, and E3) in the second inverter 21, flow into a positive electrode of the second power battery 2, and charge the second power battery 2. Charging currents then flow out from the negative electrode of the second power battery 2, flow through diodes connected in anti-parallel in the three lower bridge arms (D4, D5, and D6) in the first inverter 11, and return to the first motor 12 and the second motor 22. In this state, the first motor 12 and the second motor 22 are discharged, the second power battery 2 is charged, the first motor 12 and the second motor 22 release the electric energy stored in a previous state, and the electric energy is transferred to the second power battery 2. A voltage in the first motor 12 and a voltage in the second motor 22 drop, and a voltage of the second power battery 2 rises.

State 3: A connect/disconnect state in the first inverter 11 and a connect/disconnect state in the second inverter 21 remain unchanged. In this case, the voltage of the second power battery 2 reaches a highest level, and the current flows out from the positive electrode of the second power battery 2. The current flows through the three upper bridge arms (E1, E2, and E3) in the second inverter 21, the second motor 22, the first motor 12, and the three lower bridge arms (D4, D5, and D6) in the first inverter 11, and finally flows back to the negative electrode of the second power battery 2. In this state, the second power battery 2 is discharged, and the voltage drops. The released electric energy is stored in the first motor 12 and the second motor 22. The first motor 12 and the second motor 22 are charged, and the voltage rises.

State 4: The three upper bridge arms (D1, D2, and D3) in the first inverter 11 and the three lower bridge arms (E4, E5, and E6) in the second inverter 21 are controlled to be closed. The three lower bridge arms (D4, D5, and D6) in the first inverter 11 and the three upper bridge arms (E1, E2, and E3) in the second inverter 21 are controlled to be opened. Currents in the first motor 12 and the second motor 22 continue to flow. The freewheeling currents flow through diodes connected in anti-parallel in the three upper bridge arms (D1, D2, and D3) in the first inverter 11, flow into the positive electrode of the first power battery 1, and charge the first power battery 1. Charging currents then flow out from the negative electrode of the first power battery 1, flow through diodes connected in anti-parallel in the three lower bridge arms (E4, E5, and E6) of the second inverter 21, and return to the first motor 12 and the second motor 22. In this state, the first motor 12 and the second motor 22 are discharged, and the voltage drops. The first power battery 1 is charged, and the voltage rises.

In the battery self-heating process, both the first power battery 1 and the second power battery 2 undergo charging and discharging processes, so that a self-heating effect may be implemented through both the first power battery 1 and the second power battery 2.

In addition, in a common circuit including a motor, a current flowing through the motor needs to have different directions at any moment, to ensure that a sum of currents entering a neutral point (N point) of the motor is equal to a sum of currents flowing out of a neutral point of the motor. For example, it may be one phase in and one phase out, or one phase in and two phases out, or one phase out and two phases in. Therefore, a maximum current passing through a conventional motor may be only a current limit of one phase of the motor winding. In the schematic diagram of the battery self-heating apparatus shown in FIG. 1, because both the first motor 12 and the second motor 22 may draw the current through the neutral line connected between the first motor 12 and the second motor 22, so that currents in the three-phase motor windings in the first motor 12 and the second motor 22 may flow in a same direction. As a result, magnitudes of currents that can pass through the first motor 12 and the second motor 22 are greatly increased, and a maximum overcurrent capacity of the motor may be fully utilized. The greater the current, more heat is generated in the first power battery 1 and the second power battery 2, and therefore, battery self-heating efficiency may be further improved.

In addition, the bridge arms in the first inverter 11 and the second inverter 21 shown in FIG. 1 are three-phase bridge arms, and when each of the first motor 12 and the second motor 22 includes three motor windings, if the currents in the three motor windings in each of the first motor 12 and the second motor 22 are in a same direction, the currents in the three motor windings are equal in magnitude. An electromagnetic force synthesized in the motor is zero in real time, thereby implementing an output of zero torque. This may ensure that the motor remains static in the battery self-heating process without any additional torque control.

Through the foregoing technical solution, a battery self-heating apparatus that performs low-frequency oscillation heating by using dual motors and dual electric controls is provided, which may fully use characteristics that some electric vehicles such as a four-wheel drive electric vehicle have the dual motors and the dual electric controls. By connecting the dual motors through the neutral line, self-heating efficiency and a power of the power battery are greatly improved, and a lower cost is ensured.

FIG. 2 is a schematic diagram of a structure of a battery self-heating apparatus according to still another exemplary embodiment of the present disclosure. As shown in FIG. 2, the apparatus further includes: a first switch K1, the first switch K1 being connected between the first neutral point 13 and the second neutral point 23, and when the first switch K1 is closed, the first neutral point 13 being connected to the second neutral point 23; and the controller, being configured to control the first switch K1 to be closed in the first preset state. In other words, the first motor 12 is connected to the second motor 22 in the first preset state, to enable the first power battery 1 and the second power battery 2 to be charged/discharged through the first energy processing apparatus 10 and the second energy processing apparatus 20, to implement heating of the first power battery 1 and the second power battery 2.

In a possible implementation, as shown in FIG. 2, the apparatus further includes: a second switch K2, the second switch K2 being connected to the positive electrode of the first power battery 1, a positive electrode of the second power battery 2, the first bus terminal of the first inverter 11, and a first bus terminal of the second inverter 21, and when the second switch K2 is closed, the positive electrode of the first power battery 1, the positive electrode of the second power battery 2, the first bus terminal of the first inverter 11, and the first bus terminal of the second inverter 21 being closed; and the controller, being configured to control the first switch K1 to be opened and control the second switch K2 to be closed in a second preset state, to enable an external power supply to charge the first power battery 1 and the second power battery 2. The second preset state may be a state in which the first power battery 1 and the second power battery 2 need to be charged. For example, the vehicle has established a connection with an external charging pile, or the power of the first power battery 1 and the power of the second power battery 2 are lower than the preset power threshold. In this case, the first power battery 1 and the second power battery 2 are separately charged as independent battery packs.

In a possible implementation, the first motor 12 and the second motor 22 may be drive motors in the vehicle, and the controller is configured to control the first switch K1 and the second switch K2 to be opened in a third preset state, to enable the first power battery 1 and the second power battery 2 to drive the vehicle through the first motor 12 and the second motor 22 respectively. The third preset state is also a state in which the vehicle needs to run normally. In this state, by controlling the first switch K1 and the second switch K2 to be opened, the first motor 12 and the second motor 22 may be enabled to separately complete corresponding driving functions.

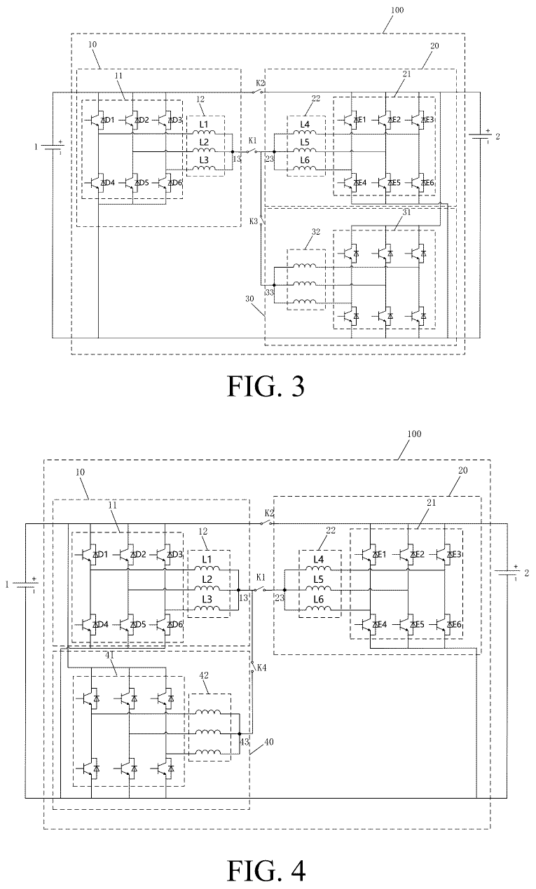

In addition, based on heating the battery in the vehicle by using dual motors and dual electronic controls to implement an oscillation heating circuit, more motors and motor controllers may be further added to the circuit to further enhance a battery self-heating effect. For example, FIG. 3 and FIG. 4 below separately show two schematic diagrams of structures of battery self-heating circuits that may be formed when there are two power batteries in the vehicle and there are three motors and three motor controllers.

FIG. 3 is a schematic diagram of a structure of a battery self-heating apparatus according to still another exemplary embodiment of the present disclosure. As shown in FIG. 3, the apparatus further includes a third energy processing apparatus 30 and a third switch K3. The third energy processing apparatus 30 includes a third inverter 31 and a third motor 32, a first bus terminal of the third inverter 31 is connected to the positive electrode of the second power battery 2, the first bus terminal of the second inverter 21, and the second switch K2, and a second bus terminal of the third inverter 31 is connected to the negative electrode of the first power battery 1, the negative electrode of the second power battery 2, the second bus terminal of the first inverter 11, and the second bus terminal of the second inverter 21, a first terminal of the third motor 32 is connected to a midpoint of the third inverter 31, a second terminal of the third motor 32 is jointly connected to form a third neutral point 33, and the third neutral point 33 is connected to the first switch K1 and the second neutral point 23 through the third switch K3. The controller is configured to control the first switch K1 and the third switch K3 to be closed and the second switch K2 to be opened in the first preset state, and control connect/disconnect of the first inverter 11, the second inverter 21, and the third inverter 31, to enable the first power battery 1 and the second power battery 2 to be charged/discharged through the first energy processing apparatus 10, the second energy processing apparatus 20, and the third energy processing apparatus 30, to implement heating of the first power battery 1 and the second power battery 2.

In one embodiment, the third energy processing apparatus 30 is connected to the second power battery 2 together with the second energy processing apparatus. In the first preset state, the controller may control the first switch K1 and the third switch K3 to be closed, and control the second switch K2 to be opened, to form a battery self-heating apparatus including the first energy processing apparatus 10, the second energy processing apparatus 20, and the third energy processing apparatus 30. A direction and a principle of a self-heating current of the battery self-heating apparatus are the same as those described in the embodiment shown in FIG. 1. Connect/disconnect of the upper bridge arm and connect/disconnect of the lower bridge arm in the third energy processing apparatus 30 are consistent with connect/disconnect of the upper bridge arm and connect/disconnect of the lower bridge arm in the second energy processing apparatus 20. The third energy processing apparatus 30 and the second energy processing apparatus 20 as a whole jointly form a current loop with the first energy processing apparatus 10, to implement charging/discharging of the first power battery 1 and the second power battery 2 in the foregoing four states. In the second preset state, the first switch K1 and the third switch K3 may be opened, and the second switch K2 may be closed, to enable an external charging device such as a charging pile to simultaneously charge the first power battery 1 and the second power battery 2 separately. In the third preset state, the first switch K1, the second switch K2, and the third switch K3 may be opened, to enable three motors in the first energy processing apparatus 10, the second energy processing apparatus 20, and the third energy processing apparatus 30 to separately provide drive for the vehicle.

FIG. 4 is a schematic diagram of a structure of a battery self-heating apparatus according to still another exemplary embodiment of the present disclosure. As shown in FIG. 4, the apparatus further includes a fourth energy processing apparatus 40 and a fourth switch K4. The fourth energy processing apparatus 40 includes a fourth inverter 41 and a fourth motor 42, a first bus terminal of the fourth inverter 41 is connected to the positive electrode of the first power battery 1, the first bus terminal of the first inverter 11, and the second switch K2, a second bus terminal of the fourth inverter 41 is connected to the negative electrode of the first power battery 1, the negative electrode of the second power battery 2, the second bus terminal of the first inverter 11, and the second bus terminal of the second inverter 21, a first terminal of the fourth motor 42 is connected to a midpoint of the fourth inverter 41, a second terminal of the fourth motor 42 is jointly connected to form a fourth neutral point 43, and the fourth neutral point 43 is connected to the first switch K1 and the first neutral point 13 through the fourth switch K4. The controller is configured to control the first switch K1 and the fourth switch K4 to be closed and control the second switch K2 to be opened in the first preset state, and control connect/disconnect of the first inverter 11, the second inverter 21, and the fourth inverter 41, to enable the first power battery 1 and the second power battery 2 to be charged/discharged through the first energy processing apparatus 10, the second energy processing apparatus 20, and the fourth energy processing apparatus 40, to implement heating of the first power battery 1 and the second power battery 2.

In one embodiment, the fourth energy processing apparatus 40 is connected to the first power battery 1 together with the first energy processing apparatus 10. In the first preset state, the first switch K1 and the fourth switch K4 are controlled to be closed, and the second switch K2 is controlled to be opened, to form a battery self-heating apparatus including the first energy processing apparatus 10, the second energy processing apparatus 20, and the fourth energy processing apparatus 40. A direction and a principle of a self-heating current of the battery self-heating apparatus are the same as those described in the embodiment shown in FIG. 1. Connect/disconnect of the upper bridge arm and connect/disconnect of the lower bridge arm in the fourth energy processing apparatus 40 are consistent with connect/disconnect of the upper bridge arm and connect/disconnect of the lower bridge arm in the first energy processing apparatus 10. The fourth energy processing apparatus 40 and the first energy processing apparatus 10 as a whole jointly form a current loop with the second energy processing apparatus 20, to implement charging/discharging of the first power battery 1 and the second power battery 2 in the foregoing four states. In the second preset state, the first switch K1 and the fourth switch K4 may be opened, and the second switch K2 may be closed, to enable an external charging device such as a charging pile to simultaneously charge the first power battery 1 and the second power battery 2 separately. In the third preset state, the first switch K1, the second switch K2, and the fourth switch K4 may be opened, to enable three motors in the first energy processing apparatus 10, the second energy processing apparatus 20, and the fourth energy processing apparatus 40 to separately provide drive for the vehicle.

In a possible implementation, the third inverter 31 and the fourth inverter 41 shown in FIG. 3 and FIG. 4 may respectively include three sets of bridge arms. Each of the third motor 32 and the fourth motor 42 may also be a three-phase motor, and includes three motor windings. In addition, in the first preset state, currents in the three motor windings in each of the third motor 32 and the fourth motor 42 are also in a same direction at each moment. Therefore, when the battery self-heating apparatus shown in FIG. 3 and FIG. 4 performs self-heating of the first power battery 1 and the second power battery 2 in the first preset state, a maximum overcurrent capacity of the third motor 32 and the fourth motor 42 may also be fully exerted, to generate more heat, and further improve the battery self-heating efficiency. In addition, when each of the third motor 32 and the fourth motor 42 includes the three motor windings, if the currents are in the same direction, the currents in the three motor windings in each of the motors are equal in magnitude. An electromagnetic force synthesized in the motor is zero in real time, thereby also implementing an output of zero torque. This ensures that the motor remains static in the battery self-heating process without any additional torque control.

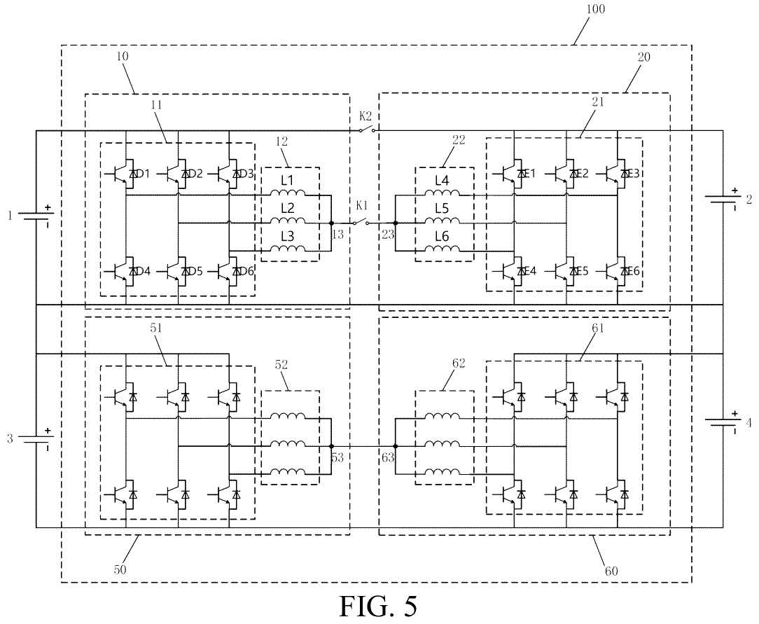

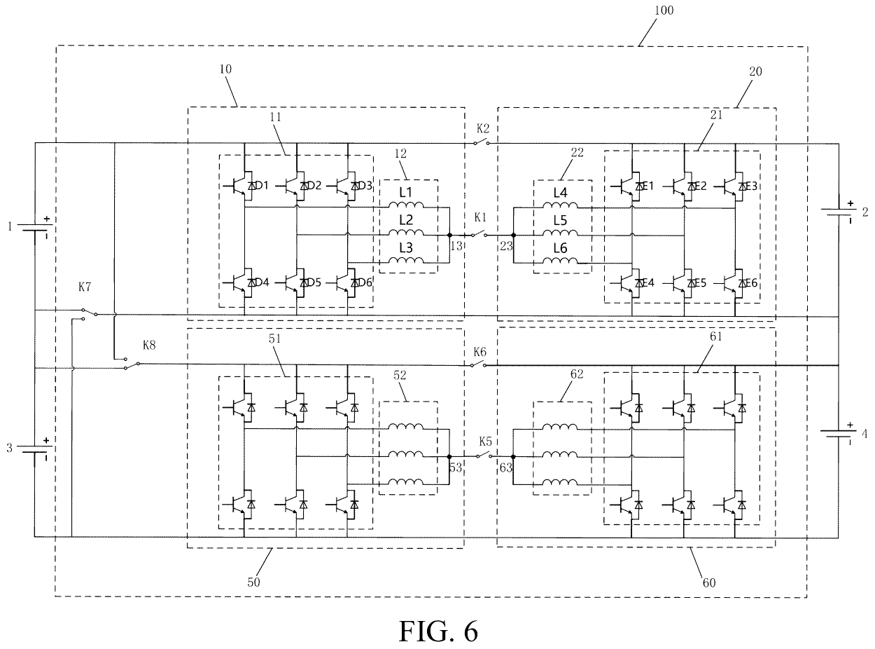

In addition, based on heating the battery in the vehicle by using dual motors and dual electronic controls to implement an oscillation heating circuit, more power batteries, motors, and motor controllers may be further used to further enhance a battery self-heating effect. For example, FIG. 5 and FIG. 6 below show two schematic diagrams of structures of battery self-heating circuits that may be formed when there are four power batteries in the vehicle and there are four motors and four motor controllers.

FIG. 5 is a schematic diagram of a structure of a battery self-heating apparatus according to still another exemplary embodiment of the present disclosure. As shown in FIG. 5, the apparatus further includes a fifth energy processing apparatus 50 and a sixth energy processing apparatus 60. The fifth energy processing apparatus 50 includes a fifth inverter 51 and a fifth motor 52, and the sixth energy processing apparatus 60 includes a sixth inverter 61 and a sixth motor 62. A first bus terminal of the fifth inverter 51 is connected to the negative electrode of the first power battery 1, the negative electrode of the second power battery 2, a positive electrode of a third power battery 3, a positive electrode of a fourth power battery 4, the second bus terminal of the first inverter 11, and the second bus terminal of the second inverter 21. A second bus terminal of the fifth inverter 51 is connected to a negative electrode of the third power battery 3, a negative electrode of a fourth power battery 4, and a second bus terminal of the sixth inverter 61. A first terminal of the fifth motor 52 is connected to a midpoint of the fifth inverter 51, a first terminal of the sixth motor 62 is connected to a midpoint of the sixth inverter 61, and a second terminal of the fifth motor 52 is jointly connected to form a fifth neutral point 53, and is connected to a sixth neutral point 63 formed by commonly connecting a second terminal of the sixth motor 62. The controller is configured to control the first switch K1 to be closed and control the second switch K2 to be opened in the first preset state, and control connect/disconnect of the first inverter 11, the second inverter 21, the fifth inverter 51, and the sixth inverter 61, to enable the first power battery 1, the second power battery 2, the third power battery 3, and the fourth power battery 4 to be charged/discharged through the first energy processing apparatus 10, the second energy processing apparatus 20, the fifth energy processing apparatus 50, and the sixth energy processing apparatus 60, to implement heating of the first power battery 1, the second power battery 2, the third power battery 3, and the fourth power battery 4.

In the first preset state, in one embodiment, an implementation for implementing battery self-heating is: controlling connect/disconnect of the first inverter 11, the second inverter 21, the third inverter 31, and the fourth inverter 41 in the first preset state, to enable the first power battery 1 and the second power battery 2 to be charged/discharged through the first energy processing apparatus 10 and the second energy processing apparatus 20, and to enable the third power battery 3 and the fourth power battery 4 to be charged/discharged through the fifth energy processing apparatus 50 and the sixth energy processing apparatus 60, to implement heating of the first power battery 1, the second power battery 2, the third power battery 3, and the fourth power battery 4. In other words, the first power battery 1 and the second power battery 2 are used as a charging/discharging group, the third power battery 3 and the fourth power battery 4 are used as a charging/discharging group, and each forms a self-heating apparatus that can perform self-heating on the power battery in the group. A direction and a principle of self-heating currents in each group are the same as those described in the embodiment shown in FIG. 1. This is not described herein again.

In addition, in this case, due to a small space in a battery pack, if there are multiple power batteries in the battery pack, and voltages between the multiple power batteries cannot be balanced, a specific potential difference is generated. Once the potential difference is generated, a current is generated. Because resistance in the battery pack is small, the current generated by the potential difference has a large impact on the battery pack, and the battery pack is prone to be burned out. Therefore, when multiple groups of power batteries are charged/discharged, power batteries belonging to a side may be considered as a whole, and an overall voltage of power batteries on each side may always be ensured to remain stable, to avoid generating the potential difference. For example, in the schematic diagram shown in FIG. 5, the first power battery 1 and the third power battery 3 may be considered as a whole, and the second power battery 2 and the fourth power battery 4 may be considered as a whole. When charging/discharging of each power battery is separately controlled, it is ensured that when the first power battery 1 charges the second power battery 2, the fourth power battery 4 charges the third power battery 3, and when the second power battery 2 charges the first power battery 1, the third power battery 3 charges the fourth power battery 4. Therefore, it may be ensured that a total voltage of the first power battery 1 and the third power battery 3, and a total voltage of the second power battery 2 and the fourth power battery 4 may remain stable. A safety risk of the battery pack caused by the potential difference is reduced.

Based on the schematic diagram of the structure of the battery self-heating apparatus shown in FIG. 5, to further implement functions of battery pack charging and motor driving, a schematic diagram of a structure of a battery self-heating apparatus shown in FIG. 6 is provided.

FIG. 6 is a schematic diagram of a structure of a battery self-heating apparatus according to still another exemplary embodiment of the present disclosure. As shown in FIG. 6, the apparatus further includes a fifth switch K5, a sixth switch K6, a seventh switch K7, and an eighth switch K8. The fifth switch K5 is connected between the fifth neutral point 53 and the sixth neutral point 63, and when the fifth switch K5 is closed, the fifth neutral point 53 is connected to the sixth neutral point 63. A first terminal of the sixth switch K6 is connected to a first bus terminal of the fifth inverter 51 and a first terminal of the eighth switch K8, a second terminal of the sixth switch K6 is connected to a first bus terminal of the sixth inverter 61, the second bus terminal of the second inverter 21, the second bus terminal of the first inverter 11, the negative electrode of the second power battery 2, the positive electrode of the fourth power battery 4, and a first terminal of the seventh switch K7, and when the sixth switch K6 is closed, the first terminal of the sixth switch K6 is connected to the second terminal of the sixth switch K6. A second terminal of the seventh switch K7 is connected to the second bus terminal of the fifth inverter 51, the second bus terminal of the sixth inverter 61, the negative electrode of the third power battery 3, and the negative electrode of the fourth power battery 4. A third terminal of the seventh switch K7 is connected to the negative electrode of the first power battery 1, the positive electrode of the third power battery 3, and a second terminal of the eighth switch K8. A third terminal of the eighth switch K8 is connected to the first bus terminal of the first inverter 11, the second switch K2, and the positive electrode of the first power battery 1.

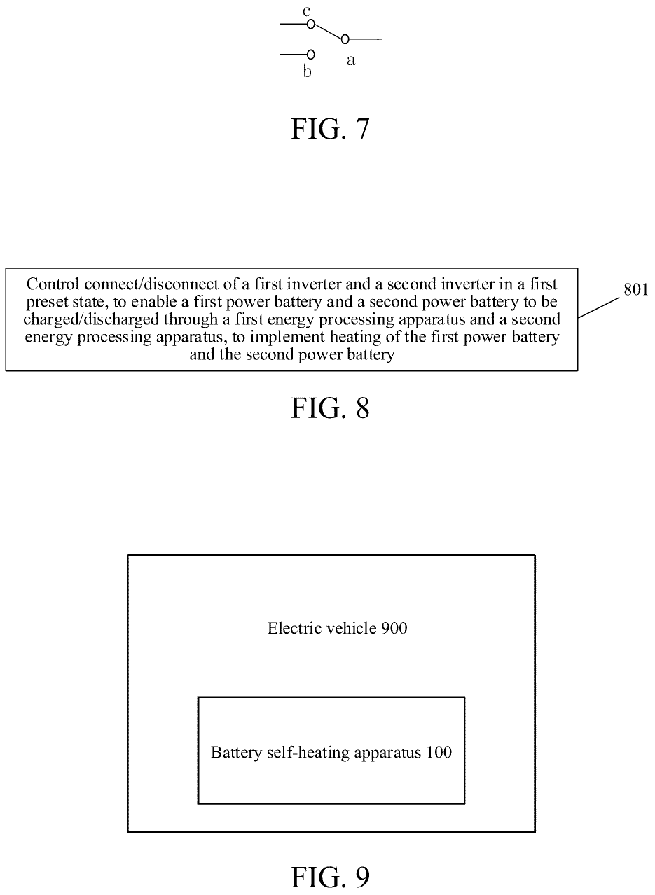

Terminal points of the seventh switch K7 and the eighth switch K8 are sorted as shown in FIG. 7, and are determined as a first terminal a, a second terminal b, and a third terminal c in clockwise order.

According to the schematic diagram of the structure shown in FIG. 5, in the first preset state, the controller in FIG. 6 should control the first switch K1 and the fifth switch K5 to be closed, control the second switch K2 and the sixth switch K6 to be opened, control the first terminal of the seventh switch K7 to be connected to the third terminal of the seventh switch K7, and control the first terminal of the eighth switch K8 to be connected to the second terminal of the eighth switch K8. In this way, connect/disconnect of the first inverter 11, the second inverter 21, the fifth inverter 51, and the sixth inverter 61 is controlled, to implement heating of the first power battery 1, the second power battery 2, the third power battery 3, and the fourth power battery 4.

In addition, the controller in FIG. 6 is further configured to control the first switch K1 and the fifth switch K5 to be opened, and control the second switch K2 and the sixth switch K6 to be closed in the second preset state, control the first terminal of the seventh switch K7 to be connected to the second terminal of the seventh switch K7, and control the first terminal of the eighth switch K8 to be connected to the third terminal of the eighth switch K8, to enable the external power supply to charge the first power battery 1, the second power battery 2, the third power battery 3, and the fourth power battery 4.

In addition, when the first motor 12, the second motor 22, the third motor 32, and the fourth motor 42 that are shown in FIG. 6 respectively are drive motors in a vehicle, the controller in FIG. 6 is further configured to control the first switch K1, the second switch K2, and the fifth switch K5, and the sixth switch K6 to be opened in a third preset state, control the first terminal of the seventh switch K7 to be connected to the third terminal of the seventh switch K7, and control the first terminal of the eighth switch K8 to be connected to the second terminal of the eighth switch K8, to enable the first power battery 1, the second power battery 2, the third power battery 3, and the fourth power battery 4 to drive the vehicle through the first motor 12, the second motor 22, the third motor 32, and the fourth motor 42 respectively.

In a possible implementation, the fifth inverter 51 and the sixth inverter 61 shown in FIG. 5 and FIG. 6 may also respectively include three sets of bridge arms. Each of the fifth motor 52 and the sixth motor 62 may also be a three-phase motor, and includes three motor windings. In addition, in the first preset state, currents in the three motor windings in each of the fifth motor 52 and the sixth motor 62 are also in a same direction at each moment. Therefore, when the battery self-heating apparatus shown in FIG. 5 and FIG. 6 performs self-heating of the first power battery 1 and the second power battery 2 in the first preset state, a maximum overcurrent capacity of the fifth motor 52 and the sixth motor 62 may also be fully exerted, to generate more heat, and further improve the battery self-heating efficiency. In addition, when each of the fifth motor 52 and the sixth motor 62 includes three motor windings, if the currents are in the same direction, the currents in the three motor windings in each of the motors are equal in magnitude. An electromagnetic force synthesized in the motor is zero in real time, thereby also implementing an output of zero torque. This also ensures that the motor remains static in the battery self-heating process without any additional torque control.

FIG. 8 is a flowchart of a battery self-heating method according to an exemplary embodiment of the present disclosure. As shown in FIG. 8, the method includes step 801.

In step 801, connect/disconnect of the first inverter 11 and the second inverter 21 is controlled in a first preset state, to enable the first power battery 1 and the second power battery 2 to be charged/discharged through the first energy processing apparatus 10 and the second energy processing apparatus 20, to implement heating of the first power battery 1 and the second power battery 2. The first energy processing apparatus 10 includes a first inverter 11 and a first motor 12, and the second energy processing apparatus 20 includes a second inverter 21 and a second motor 22. A first bus terminal of the first inverter 11 is connected to a positive electrode of a first power battery 1, a second bus terminal of the first inverter 11 is connected to a negative electrode of the first power battery 1, a negative electrode of a second power battery 2, and a second bus terminal of the second inverter 21. A first terminal of the first motor 12 is connected to a midpoint of the first inverter 11, a first terminal of the second motor 22 is connected to a midpoint of the second inverter 21, and a second terminal of the first motor 12 is jointly connected to form a first neutral point 13, and the first neutral point 13 is connected to a second neutral point 23 formed by commonly connecting a second terminal of the second motor 22, through a neutral line.

Through the foregoing technical solution, a battery self-heating apparatus that performs low-frequency oscillation heating by using dual motors and dual electric controls is provided, which may fully use characteristics that some electric vehicles such as a four-wheel drive electric vehicle have the dual motors and the dual electric controls. By connecting the dual motors through the neutral line, self-heating efficiency and a power of the power battery are greatly improved, and a lower cost is ensured.

In a possible implementation, the method further includes: controlling the first switch K1 to be closed in the first preset state. The first switch K1 is connected between the first neutral point 13 and the second neutral point 23, and when the first switch K1 is closed, the first neutral point 13 is connected to the second neutral point 23.

In a possible implementation, the method further includes: controlling the first switch K1 to be opened and controlling the second switch K2 to be closed in a second preset state, to enable an external power supply to charge the first power battery 1 and the second power battery 2. The second switch K2 is connected to the positive electrode of the first power battery 1, a positive electrode of the second power battery 2, the first bus terminal of the first inverter 11, and a first bus terminal of the second inverter 21, and when the second switch K2 is closed, the positive electrode of the first power battery 1, the positive electrode of the second power battery 2, the first bus terminal of the first inverter 11, and the first bus terminal of the second inverter 21 are closed.

In a possible implementation, the method further includes: controlling an upper bridge arm of the first inverter 11 and a lower bridge arm of the second inverter 21 to be simultaneously closed in the first preset state, or controlling a lower bridge arm of the first inverter 11 and an upper bridge arm of the second inverter 21 to be simultaneously closed, to enable the first power battery 1 and the second power battery 2 to be charged/discharged through the first energy processing apparatus 10 and the second energy processing apparatus 20, to implement heating of the first power battery 1 and the second power battery 2.

In a possible implementation, the method further includes: controlling the first switch K1 and the third switch K3 to be closed and the second switch K2 to be opened in the first preset state, and controlling connect/disconnect of the first inverter 11, the second inverter 21, and the third inverter 31, to enable the first power battery 1 and the second power battery 2 to be charged/discharged through the first energy processing apparatus 10, the second energy processing apparatus 20, and the third energy processing apparatus 30, to implement heating of the first power battery 1 and the second power battery 2. The third energy processing apparatus 30 includes a third inverter 31 and a third motor 32, a first bus terminal of the third inverter 31 is connected to the positive electrode of the second power battery 2, the first bus terminal of the second inverter 21, and the second switch K2, and a second bus terminal of the third inverter 31 is connected to the negative electrode of the first power battery 1, the negative electrode of the second power battery 2, the second bus terminal of the first inverter 11, and the second bus terminal of the second inverter 21, a first terminal of the third motor 32 is connected to a midpoint of the third inverter 31, a second terminal of the third motor 32 is jointly connected to form a third neutral point 33, and the third neutral point 33 is connected to the first switch K1 and the second neutral point 23 through the third switch K3.

In a possible implementation, the method further includes: controlling the first switch K1 and the fourth switch K4 to be closed and controlling the second switch K2 to be opened in the first preset state, and controlling connect/disconnect of the first inverter 11, the second inverter 21, and the fourth inverter 41, to enable the first power battery 1 and the second power battery 2 to be charged/discharged through the first energy processing apparatus 10, the second energy processing apparatus 20, and the fourth energy processing apparatus 40, to implement heating of the first power battery 1 and the second power battery 2. The fourth energy processing apparatus 40 includes a fourth inverter 41 and a fourth motor 42, a first bus terminal of the fourth inverter 41 is connected to the positive electrode of the first power battery 1, the first bus terminal of the first inverter 11, and the second switch K2, a second bus terminal of the fourth inverter 41 is connected to the negative electrode of the first power battery 1, the negative electrode of the second power battery 2, the second bus terminal of the first inverter 11, and the second bus terminal of the second inverter 21, a first terminal of the fourth motor 42 is connected to a midpoint of the fourth inverter 41, a second terminal of the fourth motor 42 is jointly connected to form a fourth neutral point 43, and the fourth neutral point 43 is connected to the first switch K1 and the first neutral point 13 through the fourth switch K4.

In a possible implementation, the method further includes: controlling the first switch K1 to be closed and controlling the second switch K2 to be opened in the first preset state, and controlling connect/disconnect of the first inverter 11, the second inverter 21, the fifth inverter 51, and the sixth inverter 61, to enable the first power battery 1, the second power battery 2, the third power battery 3, and the fourth power battery 4 to be charged/discharged through the first energy processing apparatus 10, the second energy processing apparatus 20, the fifth energy processing apparatus 50, and the sixth energy processing apparatus 60, to implement heating of the first power battery 1, the second power battery 2, the third power battery 3, and the fourth power battery 4. The fifth energy processing apparatus 50 includes a fifth inverter 51 and a fifth motor 52, and the sixth energy processing apparatus 60 includes a sixth inverter 61 and a sixth motor 62. A first bus terminal of the fifth inverter 51 is connected to the negative electrode of the first power battery 1, the negative electrode of the second power battery 2, a positive electrode of a third power battery 3, a positive electrode of a fourth power battery 4, the second bus terminal of the first inverter 11, and the second bus terminal of the second inverter 21. A second bus terminal of the fifth inverter 51 is connected to a negative electrode of the third power battery 3, a negative electrode of a fourth power battery 4, and a second bus terminal of the sixth inverter 61. A first terminal of the fifth motor 52 is connected to a midpoint of the fifth inverter 51, a first terminal of the sixth motor 62 is connected to a midpoint of the sixth inverter 61, and a second terminal of the fifth motor 52 is jointly connected to form a fifth neutral point 53, and is connected to a sixth neutral point 63 formed by commonly connecting a second terminal of the sixth motor 62.

In a possible implementation, the method further includes: controlling the first switch K1 and the fifth switch K5 to be opened, and controlling the second switch K2 and the sixth switch K6 to be closed in the second preset state, controlling the first terminal of the seventh switch K7 to be connected to the second terminal of the seventh switch K7, and controlling the first terminal of the eighth switch K8 to be connected to the third terminal of the eighth switch K8, to enable the external power supply to charge the first power battery 1, the second power battery 2, the third power battery 3, and the fourth power battery 4. The fifth switch K5 is connected between the fifth neutral point 53 and the sixth neutral point 63, and when the fifth switch K5 is closed, the fifth neutral point 53 is connected to the sixth neutral point 63. A first terminal of the sixth switch K6 is connected to a first bus terminal of the fifth inverter 51 and a first terminal of the eighth switch K8, a second terminal of the sixth switch K6 is connected to a first bus terminal of the sixth inverter 61, the second bus terminal of the second inverter 21, the second bus terminal of the first inverter 11, the negative electrode of the second power battery 2, the positive electrode of the fourth power battery 4, and a first terminal of the seventh switch K7, and when the sixth switch K6 is closed, the first terminal of the sixth switch K6 is connected to the second terminal of the sixth switch K6. A second terminal of the seventh switch K7 is connected to the second bus terminal of the fifth inverter 51, the second bus terminal of the sixth inverter 61, the negative electrode of the third power battery 3, and the negative electrode of the fourth power battery 4. A third terminal of the seventh switch K7 is connected to the negative electrode of the first power battery 1, the positive electrode of the third power battery 3, and a second terminal of the eighth switch K8. A third terminal of the eighth switch K8 is connected to the first bus terminal of the first inverter 11, the second switch K2, and the positive electrode of the first power battery 1.

In a possible implementation, the method further includes: controlling connect/disconnect of the first inverter 11, the second inverter 21, the third inverter 31, and the fourth inverter 41 in the first preset state, to enable the first power battery 1 and the second power battery 2 to be charged/discharged through the first energy processing apparatus 10 and the second energy processing apparatus 20, and to enable the third power battery 3 and the fourth power battery 4 to be charged/discharged through the fifth energy processing apparatus 50 and the sixth energy processing apparatus 60, to implement heating of the first power battery 1, the second power battery 2, the third power battery 3, and the fourth power battery 4. When the first power battery 1 charges the second power battery 2, the fourth power battery 4 charges the third power battery 3, and when the second power battery 2 charges the first power battery 1, the third power battery 3 charges the fourth power battery 4.

In a possible implementation, the method further includes: controlling the first switch K1, the second switch K2, the fifth switch K5, and the sixth K6 switch to be opened in a third preset state, controlling the first terminal of the seventh switch K7 to be connected to the third terminal of the seventh switch K7, and controlling the first terminal of the eighth switch K8 to be connected to the second terminal of the eighth switch K8, to enable the first power battery 1, the second power battery 2, the third power battery 3, and the fourth power battery 4 to drive the vehicle through the first motor 12, the second motor 22, the third motor 32, and the fourth motor 42 respectively. The first motor 12, the second motor 22, the third motor 32, and the fourth motor 42 are separately drive motors in the vehicle.

In a possible implementation, the first inverter 11, the second inverter 21, the fifth inverter 51, and the sixth inverter 61 respectively include three sets of bridge arms. Each of the first motor 12, the second motor 22, the fifth motor 52, and the sixth motor 62 is a three-phase motor, and includes three motor windings, and in the first preset state, currents in the three motor windings in each of the first motor 12, the second motor 22, the fifth motor 52, and the sixth motor 62 are in a same direction at each moment.

In a possible implementation, the method further includes: exporting, in the first preset state, heat generated by the first power battery and the second power battery to a vehicle passenger compartment through a heat pump to provide a heat source.

FIG. 9 is a structural block diagram of an electric vehicle 900 according to an exemplary embodiment of the present disclosure. As shown in FIG. 9, the electric vehicle 900 includes the battery self-heating apparatus 100. The controller in the battery self-heating apparatus 100 may be further configured to perform all or part of steps in the battery self-heating method. A person skilled in the art should know that during specific implementation, the vehicle 900 further includes other components. FIG. 9 shows only parts related to embodiments of the present disclosure, and other necessary vehicle components are not shown one by one.

The preferred implementations of the present disclosure are described above in detail with reference to the accompanying drawings, but the present disclosure is not limited to the specific details in the above implementations. Various simple variations may be made to the technical solutions of the present disclosure within the scope of the technical idea of the present disclosure, and such simple variations shall all fall within the protection scope of the present disclosure.

It should be additionally noted that, the specific technical features described in the foregoing specific implementations may be combined in any proper manner in a case without conflict. To avoid unnecessary repetition, various possible combination manners are not described in the present disclosure.

In addition, different implementations of the present disclosure may also be arbitrarily combined without departing from the idea of the present disclosure, and these combinations shall still be considered as content disclosed in the present disclosure.

Reference numerals: 1 First power battery 2 second power battery, 3 third power battery 4 fourth power battery, 10 first energy processing apparatus 20 second energy processing apparatus, 30 third energy processing apparatus 40 fourth energy processing apparatus, 50 fifth energy processing apparatus 60 sixth energy processing apparatus, 11 first inverter 21 second inverter, 31 third inverter 41 fourth inverter, 51 fifth inverter 61 sixth inverter, 12 first motor 22 second motor, 32 third motor 42 fourth motor, 52 fifth motor 62 sixth motor, 13 first neutral point 23 second neutral point, 33 third neutral point 43 fourth neutral point, 53 fifth neutral point 63 sixth neutral point, K1 first switch K2 second switch, K3 third switch K4 fourth switch, K5 fifth switch K6 sixth switch, K7 seventh switch K8 eighth switch, 100 battery self-heating apparatus 900 vehicle.

What is claimed is:

1. A battery self-heating apparatus, comprising a first energy processing apparatus, a second energy processing apparatus, and a controller connected to each other, wherein
the first energy processing apparatus comprises a first inverter and a first motor, and the second energy processing apparatus comprises a second inverter and a second motor; a first bus terminal of the first inverter is connected to a positive electrode of a first power battery, a second bus terminal of the first inverter is connected to a negative electrode of the first power battery, a negative electrode of a second power battery, and a second bus terminal of the second inverter;
a first terminal of the first motor is connected to a midpoint of the first inverter, a first terminal of the second motor is connected to a midpoint of the second inverter, and a second terminal of the first motor is jointly connected to form a first neutral point, and the first neutral point is connected to a second neutral point, formed by commonly connecting a second terminal of the second motor, through a neutral line; and
the controller is configured to control connect/disconnect of the first inverter and the second inverter in a first preset state, to enable the first power battery and the second power battery to be charged/discharged through the first energy processing apparatus and the second energy processing apparatus, to implement heating of the first power battery and the second power battery.

2. The apparatus according to claim 1, further comprising:
a first switch, the first switch being connected between the first neutral point and the second neutral point, and when the first switch is closed, the first neutral point being connected to the second neutral point; and
the controller, being configured to control the first switch to be closed in the first preset state.

3. The apparatus according to claim 1, further comprising:
a second switch, the second switch being connected to the positive electrode of the first power battery, a positive electrode of the second power battery, the first bus terminal of the first inverter, and a first bus terminal of the second inverter, and when the second switch is closed, the positive electrode of the first power battery, the positive electrode of the second power battery, the first bus terminal of the first inverter, and the first bus terminal of the second inverter being closed; and
the controller, being configured to control the first switch to be opened and control the second switch to be closed in a second preset state, to enable an external power supply to charge the first power battery and the second power battery.

4. The apparatus according to claim 1, wherein
the controller is configured to control an upper bridge arm of the first inverter and a lower bridge arm of the second inverter to be simultaneously closed in the first preset state, or control a lower bridge arm of the first inverter and an upper bridge arm of the second inverter to be simultaneously closed, to enable the first power battery and the second power battery to be charged/discharged through the first energy processing apparatus and the second energy processing apparatus, to implement heating of the first power battery and the second power battery.

5. The apparatus according to claim 1, further comprising a third energy processing apparatus and a third switch, wherein
the third energy processing apparatus comprises a third inverter and a third motor, a first bus terminal of the third inverter is connected to the positive electrode of the second power battery, the first bus terminal of the second inverter, and the second switch, and a second bus terminal of the third inverter is connected to the negative electrode of the first power battery, the negative electrode of the second power battery, the second bus terminal of the first inverter, and the second bus terminal of the second inverter;
a first terminal of the third motor is connected to a midpoint of the third inverter, a second terminal of the third motor is jointly connected to form a third neutral point, and the third neutral point is connected to the first switch and the second neutral point through the third switch; and
the controller is configured to control the first switch and the third switch to be closed and control the second switch to be opened in the first preset state, and control connect/disconnect of the first inverter, the second inverter, and the third inverter, to enable the first power battery and the second power battery to be charged/discharged through the first energy processing apparatus, the second energy processing apparatus, and the third energy processing apparatus, to implement heating of the first power battery and the second power battery.

6. The apparatus according to claim 1, further comprising a fourth energy processing apparatus and a fourth switch, wherein
the fourth energy processing apparatus comprises a fourth inverter and a fourth motor, a first bus terminal of the fourth inverter is connected to the positive electrode of the first power battery, the first bus terminal of the first inverter, and the second switch, and a second bus terminal of the fourth inverter is connected to the negative electrode of the first power battery, the negative electrode of the second power battery, the second bus terminal of the first inverter, and the second bus terminal of the second inverter;
a first terminal of the fourth motor is connected to a midpoint of the fourth inverter, a second terminal of the fourth motor is jointly connected to form a fourth neutral point, and the fourth neutral point is connected to the first switch and the first neutral point through the fourth switch; and
the controller is configured to control the first switch and the fourth switch to be closed and control the second switch to be opened in the first preset state, and control connect/disconnect of the first inverter, the second inverter, and the fourth inverter, to enable the first power battery and the second power battery to be charged/discharged through the first energy processing apparatus, the second energy processing apparatus, and the fourth energy processing apparatus, to implement heating of the first power battery and the second power battery.

7. The apparatus according to claim 1, further comprising a fifth energy processing apparatus and a sixth energy processing apparatus, wherein
the fifth energy processing apparatus comprises a fifth inverter and a fifth motor, and the sixth energy processing apparatus comprises a sixth inverter and a sixth motor;
a first bus terminal of the fifth inverter is connected to the negative electrode of the first power battery, the negative electrode of the second power battery, a positive electrode of a third power battery, a positive electrode of a fourth power battery, the second bus terminal of the first inverter, and the second bus terminal of the second inverter; a second bus terminal of the fifth inverter is connected to a negative electrode of the third power battery, a negative electrode of a fourth power battery, and a second bus terminal of the sixth inverter;
a first terminal of the fifth motor is connected to a midpoint of the fifth inverter, a first terminal of the sixth motor is connected to a midpoint of the sixth inverter, and a second terminal of the fifth motor is jointly connected to form a fifth neutral point, and is connected to a sixth neutral point formed by commonly connecting a second terminal of the sixth motor; and
the controller is configured to control the first switch to be closed and control the second switch to be opened in the first preset state, and control connect/disconnect of the first inverter, the second inverter, the fifth inverter, and the sixth inverter, to enable the first power battery, the second power battery, the third power battery, and the fourth power battery to be charged/discharged through the first energy processing apparatus, the second energy processing apparatus, the fifth energy processing apparatus, and the sixth energy processing apparatus, to implement heating of the first power battery, the second power battery, the third power battery, and the fourth power battery.

8. The apparatus according to claim 7, further comprising a fifth switch, a sixth switch, a seventh switch, and an eighth switch, wherein
the fifth switch is connected between the fifth neutral point and the sixth neutral point, and when the fifth switch is closed, the fifth neutral point is connected to the sixth neutral point;
a first terminal of the sixth switch is connected to the first bus terminal of the fifth inverter and a first terminal of the eighth switch, a second terminal of the sixth switch is connected to a first bus terminal of the sixth inverter, the second bus terminal of the second inverter, the second bus terminal of the first inverter, the negative electrode of the second power battery, the positive electrode of the fourth power battery, and a first terminal of the seventh switch, and when the sixth switch is closed, the first terminal of the sixth switch is connected to the second terminal of the sixth switch;
a second terminal of the seventh switch is connected to the second bus terminal of the fifth inverter, the second bus terminal of the sixth inverter, the negative electrode of the third power battery, and the negative electrode of the fourth power battery; a third terminal of the seventh switch is connected to the negative electrode of the first power battery, the positive electrode of the third power battery, and a second terminal of the eighth switch;
a third terminal of the eighth switch is connected to the first bus terminal of the first inverter, the second switch, and the positive electrode of the first power battery; and
the controller is configured to control the first switch and the fifth switch to be opened, and control the second switch and the sixth switch to be closed in the second preset state, control the first terminal of the seventh switch to be connected to the second terminal of the seventh switch, and control the first terminal of the eighth switch to be connected to the third terminal of the eighth switch, to enable the external power supply to charge the first power battery, the second power battery, the third power battery, and the fourth power battery.

9. The apparatus according to claim 8, wherein
the controller is configured to control connect/disconnect of the first inverter, the second inverter, the third inverter, and the fourth inverter in the first preset state, to enable the first power battery and the second power battery to be charged/discharged through the first energy processing apparatus and the second energy processing apparatus, and to enable the third power battery and the fourth power battery to be charged/discharged through the fifth energy processing apparatus and the sixth energy processing apparatus, to implement heating of the first power battery, the second power battery, the third power battery, and the fourth power battery, wherein
when the first power battery charges the second power battery, the fourth power battery charges the third power battery, and when the second power battery charges the first power battery, the third power battery charges the fourth power battery.

10. The apparatus according to claim 8, wherein the first motor, the second motor, the third motor, and the fourth motor respectively are drive motors in a vehicle, wherein
the controller is configured to control the first switch, the second switch, the fifth switch, and the sixth switch to be opened in a third preset state, control the first terminal of the seventh switch to be connected to the third terminal of the seventh switch, and control the first terminal of the eighth switch to be connected to the second terminal of the eighth switch, to enable the first power battery, the second power battery, the third power battery, and the fourth power battery to drive the vehicle through the first motor, the second motor, the third motor, and the fourth motor respectively.

11. The apparatus according to claim 8, wherein the first inverter, the second inverter, the fifth inverter, and the sixth inverter respectively comprise three sets of bridge arms; and each of the first motor, the second motor, the fifth motor, and the sixth motor is a three-phase motor, and comprises three motor windings, and in the first preset state, currents in the three motor windings in each of the first motor, the second motor, the third motor, and the fourth motor are in a same direction at each moment.

12. The apparatus according to claim 1, wherein
the controller is configured to export, in the first preset state, heat generated by the first power battery and the second power battery to a vehicle passenger compartment through a heat pump to provide a heat source.

13. A battery self-heating method, comprising:
controlling connect/disconnect of a first inverter and a second inverter in a first preset state, to enable a first power battery and a second power battery to be charged/discharged through a first energy processing apparatus and a second energy processing apparatus, to implement heating of the first power battery and the second power battery, wherein
the first energy processing apparatus comprises the first inverter and a first motor, and the second energy processing apparatus comprises the second inverter and a second motor; a first bus terminal of the first inverter is connected to a positive electrode of the first power battery, and a second bus terminal of the first inverter is connected to a negative electrode of the first power battery, a negative electrode of the second power battery, and a second bus terminal of the second inverter; and a first terminal of the first motor is connected to a midpoint of the first inverter, a first terminal of the second motor is connected to a midpoint of the second inverter, and a second terminal of the first motor is jointly connected to form a first neutral point, and the first neutral point is connected to a second neutral point, formed by commonly connecting a second terminal of the second motor, through a neutral line.

14. An electric vehicle, comprising a battery self-heating apparatus, the battery self-heating apparatus comprising a first energy processing apparatus, a second energy processing apparatus, and a controller connected to each other, wherein
the first energy processing apparatus comprises a first inverter and a first motor, and the second energy processing apparatus comprises a second inverter and a second motor; a first bus terminal of the first inverter is connected to a positive electrode of a first power battery, a second bus terminal of the first inverter is connected to a negative electrode of the first power battery, a negative electrode of a second power battery, and a second bus terminal of the second inverter;
a first terminal of the first motor is connected to a midpoint of the first inverter, a first terminal of the second motor is connected to a midpoint of the second inverter, and a second terminal of the first motor is jointly connected to form a first neutral point, and the first neutral point is connected to a second neutral point, formed by commonly connecting a second terminal of the second motor, through a neutral line; and
the controller is configured to control connect/disconnect of the first inverter and the second inverter in a first preset state, to enable the first power battery and the second power battery to be charged/discharged through the first energy processing apparatus and the second energy processing apparatus, to implement heating of the first power battery and the second power battery.

15. The electric vehicle according to claim 14, the battery self-heating apparatus further comprising:
a first switch, the first switch being connected between the first neutral point and the second neutral point, and when the first switch is closed, the first neutral point being connected to the second neutral point; and
the controller, being configured to control the first switch to be closed in the first preset state.

16. The electric vehicle according to claim 14, the battery self-heating apparatus further comprising:
a second switch, the second switch being connected to the positive electrode of the first power battery, a positive electrode of the second power battery, the first bus terminal of the first inverter, and a first bus terminal of the second inverter, and when the second switch is closed, the positive electrode of the first power battery, the positive electrode of the second power battery, the first bus terminal of the first inverter, and the first bus terminal of the second inverter being closed; and
the controller, being configured to control the first switch to be opened and control the second switch to be closed in a second preset state, to enable an external power supply to charge the first power battery and the second power battery.

17. The electric vehicle according to claim 14, wherein
the controller is configured to control an upper bridge arm of the first inverter and a lower bridge arm of the second inverter to be simultaneously closed in the first preset state, or control a lower bridge arm of the first inverter and an upper bridge arm of the second inverter to be simultaneously closed, to enable the first power battery and the second power battery to be charged/discharged through the first energy processing apparatus and the second energy processing apparatus, to implement heating of the first power battery and the second power battery.

18. The electric vehicle according to claim 14, the battery self-heating apparatus further comprising a third energy processing apparatus and a third switch, wherein
the third energy processing apparatus comprises a third inverter and a third motor, a first bus terminal of the third inverter is connected to the positive electrode of the second power battery, the first bus terminal of the second inverter, and the second switch, and a second bus terminal of the third inverter is connected to the negative electrode of the first power battery, the negative electrode of the second power battery, the second bus terminal of the first inverter, and the second bus terminal of the second inverter;
a first terminal of the third motor is connected to a midpoint of the third inverter, a second terminal of the third motor is jointly connected to form a third neutral point, and the third neutral point is connected to the first switch and the second neutral point through the third switch; and
the controller is configured to control the first switch and the third switch to be closed and control the second switch to be opened in the first preset state, and control connect/disconnect of the first inverter, the second inverter, and the third inverter, to enable the first power battery and the second power battery to be charged/discharged through the first energy processing apparatus, the second energy processing apparatus, and the third energy processing apparatus, to implement heating of the first power battery and the second power battery.

19. The electric vehicle according to claim 14, the battery self-heating apparatus further comprising a fourth energy processing apparatus and a fourth switch, wherein
the fourth energy processing apparatus comprises a fourth inverter and a fourth motor, a first bus terminal of the fourth inverter is connected to the positive electrode of the first power battery, the first bus terminal of the first inverter, and the second switch, and a second bus terminal of the fourth inverter is connected to the negative electrode of the first power battery, the negative electrode of the second power battery, the second bus terminal of the first inverter, and the second bus terminal of the second inverter;
a first terminal of the fourth motor is connected to a midpoint of the fourth inverter, a second terminal of the fourth motor is jointly connected to form a fourth neutral point, and the fourth neutral point is connected to the first switch and the first neutral point through the fourth switch; and
the controller is configured to control the first switch and the fourth switch to be closed and control the second switch to be opened in the first preset state, and control connect/disconnect of the first inverter, the second inverter, and the fourth inverter, to enable the first power battery and the second power battery to be charged/discharged through the first energy processing apparatus, the second energy processing apparatus, and the fourth energy processing apparatus, to implement heating of the first power battery and the second power battery.

20. The electric vehicle according to claim 14, the battery self-heating apparatus further comprising a fifth energy processing apparatus and a sixth energy processing apparatus, wherein
the fifth energy processing apparatus comprises a fifth inverter and a fifth motor, and the sixth energy processing apparatus comprises a sixth inverter and a sixth motor;
a first bus terminal of the fifth inverter is connected to the negative electrode of the first power battery, the negative electrode of the second power battery, a positive electrode of a third power battery, a positive electrode of a fourth power battery, the second bus terminal of the first inverter, and the second bus terminal of the second inverter; a second bus terminal of the fifth inverter is connected to a negative electrode of the third power battery, a negative electrode of a fourth power battery, and a second bus terminal of the sixth inverter;
a first terminal of the fifth motor is connected to a midpoint of the fifth inverter, a first terminal of the sixth motor is connected to a midpoint of the sixth inverter, and a second terminal of the fifth motor is jointly connected to form a fifth neutral point, and is connected to a sixth neutral point formed by commonly connecting a second terminal of the sixth motor; and
the controller is configured to control the first switch to be closed and control the second switch to be opened in the first preset state, and control connect/disconnect of the first inverter, the second inverter, the fifth inverter, and the sixth inverter, to enable the first power battery, the second power battery, the third power battery, and the fourth power battery to be charged/discharged through the first energy processing apparatus, the second energy processing apparatus, the fifth energy processing apparatus, and the sixth energy processing apparatus, to implement heating of the first power battery, the second power battery, the third power battery, and the fourth power battery.
